(19) United States
(12) Patent Application Publication
(10) Pub. No.: US 2026/0326295 A1
(43) Pub. Date: Oct. 22, 2026

(54) MICROSERVICE-BASED SOLUTION FOR ROBOT MOTION PLANNING

(71) Applicant: SONY GROUP CORPORATION, Tokyo (JP)

(72) Inventors: David M.S. Johnson, Cambridge, MA (US); Anthony Tayoun, North Reading, MA (US); Sadra Sadraddini, Watertown, MA (US); Brook Stevens, Arlington, MA (US); David Bambrick, Cambridge, MA (US); Ramy Yammine, Somerville, MA (US)

(21) Appl. No.: 19/185,940

(22) Filed: Apr. 22, 2025

(51) Int. Cl. B25J 9/16

(52) U.S. Cl. CPC B25J 9/1664

(57) ABSTRACT

A microservice solves task and motion plans using a graph-of-convex-sets approach. The goal is to achieve time-optimal robot trajectories that are guaranteed to satisfy constraints, such as collision avoidance, end-effector pose and recipe-specific dynamic limits. The planning service includes a plurality of microservices, including one or more of a motion planner, an artifact builder, a visualizer, a planner, a service API and a service client. The planning service can use a combination of discrete and smooth optimizations under a graph of convex sets approach.

### BACKGROUND OF THE INVENTION

### 1. Field of the Invention

Embodiments of the invention relate generally to systems and methods of robot motion planning. More particularly, embodiments of the invention relate to methods and systems for a microservice-based solution that includes a suite of microservices related to motion planning to solve motion plans using a combination of sampling-based and optimization-based methods. This micro-service allows motion plans to be specified with heterogenous sets of geometric, kinematic, and dynamic constraints for multiple robots (including robot arms, grippers, legged robots, wheeled robots, and others), and each robot can have a different goal. The motion-planner is able to smoothly update plans in motion based on external or internal signals without requiring the robot(s) to stop.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

There is a need for time-optimal robot trajectories that are guaranteed to satisfy constraints. Examples of constraints include collision avoidance, end-effector pose, task-specific dynamic limits, task-specific waypoints which the trajectory must pass through, kinematic constraints such as joint limits, and the like. Conventional motion planning approaches generate waypoints from sample-based planning and connect them with a spline which is timed to make it dynamically feasible. These conventional approaches are typically not reliable, as the spline can deviate from the piecewise linear plan and may be invalid. For roadmaps, the resulting paths are often not optimal, as discrete search on a graph is not amenable to continuous optimization; and these approaches require convoluted engineering, such as using shaping cost functions to boost reliability and improve their performance.

In view of the foregoing, there is a need for improved systems and methods for motion planning to solve motion plans. plans.

### SUMMARY OF THE INVENTION

Embodiments of the present invention constitute a system for robot motion planning comprising a planner, which given a planning problem, solves a motion plan; an artifact builder, which updates or generates one or more planning artifacts; a visualizer, which displays the given context in a visualizer session; and a service client which provides an interface for an end user.

Features of the motion planning system include, as non-limiting examples, the following: (1) Update an existing motion plan, which is already running on a robot, in a dynamic consistent fashion so that it is continuous and does not exceed dynamic limits; (2) Plan a new motion for a robot, while other robots are already executing their own motion plans. The solution may or may not change the plans of the other robots depending on user inputs; (3) Heterogenous constraints: the constraints, including boundary conditions, intermediate points and velocities which must be passed through, and the goal can be different between all the robots; (4) The back-end planner can be different, either GCS, RRT (and equivalents), or trajectory optimization; (5) The constraints and goals can be specified by an external signal such as a learned model; (6) Artifact generation: GCS regions and IK cache are generated from a sparse roadmap which is generated from RRT solutions of historical planning problems, in other words, the robot learns from experience to generate most efficient artifacts (algorithm: generated IRIS regions from edges); and (7) Register geometry and adapt.

In some embodiments, which may be combined with the above embodiment, the motion planning problem includes a robot model, a set of user-defined constraints, start state data and goal state data for a robot, and/or current robot trajectories to be updated in a smooth way.

In some embodiments, which may be combined with any of the above embodiments, the motion plan is provided as a function that maps time to robot joint positions in order to drive the robot under the motion plan.

In some embodiments, which may be combined with any of the above embodiments, the motion planner loads at runtime one or more planning artifacts whose data is used to compute solutions to new planning problems. Typically, the motion planner can (1) build the artifacts, then (2) load them at runtime into the planner.

In some embodiments, which may be combined with any of the above embodiments, the artifact builder generates the one or more planning artifacts based on the robot model and the set of user-defined constraints (the “scene”).

In some embodiments, which may be combined with any of the above embodiments, the one or more planning artifacts include convex regions and configuration space roadmaps (vertices and edges) in the robot system configuration space.

In some embodiments, which may be combined with any of the above embodiments, the generation of artifacts takes advantage of sampling-based and optimization-based techniques such that artifacts enable the planner to produce motion plans.

In some embodiments, which may be combined with any of the above embodiments, in addition to the generation of novel artifacts, the artifact build will use historical data collected from prior on-robot operation to improve on existing sets of artifacts.

In some embodiments, which may be combined with any of the above embodiments, generation of artifacts for a novel scene may reuse artifacts from the closest existing scene via a migration procedure such that artifacts are not recomputed from scratch but pruned to make it compatible with the new scene. providing between one or two orders of magnitude improvement on artifact generation time.

In some embodiments, which may be combined with any of the above embodiments, the artifact builder is operable to run ahead of on-robot operation, and to deploy the one or more generated planning artifacts alongside the motion planner at runtime.

In some embodiments, which may be combined with any of the above embodiments, the visualizer provides one or more of: visualization of the scene as well as the generated planning artifacts; visualization of trajectory playback; visualization of geometric constraints; visualization of measured collisions for a given configuration; visualization and control of a simulated robot model; visualization of real-time robot joint positions.

In some embodiments, which may be combined with any of the above embodiments, the system further comprises a service application programming interface to receive service data.

In some embodiments, which may be combined with any of the above embodiments, the service data include one or more of planning problem definitions, artifact generation, robot pose calculation and checking for satisfaction of a set of constraints.

Embodiments of the present invention provide a method and a non-transitory computer readable storage medium tangibly embodying a computer readable program code having computer readable instructions that, when executed, causes a computer device to carry out a method of generating a motion plan for robot motion, the method comprising receiving a motion planning problem and generating the motion plan by a motion planner; generating one or more planning artifacts for a given context with an artifact builder; displaying one or more of a visualization of the generated planning artifacts, a visualization of geometric constraints, a visualization of a trajectory playback, a visualization of joint sliders and a position streaming support for live robots in a visualizer session; and providing a service client as an interface for an end user.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a connected experience roadmap built by sample-based generation algorithms for a simple example of a two-dimensional robot;

FIG. 2 illustrates an intermediate state of the GCS cover where safe polytopes are generated from roadmap edges, always forming a connected GCS graph;

FIG. 3 illustrates a later state of the GCS cover, where safe polytopes are connected and covering the entire roadmap which provides a motion plan solution using GCS that is more optimal than that of the roadmap alone, as illustrated in FIG. 1;

FIG. 4 illustrates a schematic representation showing how a planning problem database that provides an experience roadmap can be used to construct connected roadmaps and artifacts can be built, including IRIS regions and IK cache databases. IK cache is populated from experience which leads to continuous improvement and allows for solving IK problems during runtime without causing delays in planning

FIG. 5 illustrates how motion splines can be updated on-the-fly in a smooth way so that change of motion can be executed without the need for the robot to come to a complete stop;

FIG. 6 illustrates how motion splines can be computed for multiple arms, such that an end time of each arm is different;

FIG. 7 illustrates how motion splines can be computed for one or more robots while plans for the other arm(s) are running;

FIG. 8 illustrates how motion splines can be computed across multiple robots with different types of plans, such as waypoint following plans and goal reaching plans; and

FIG. 9 illustrates a software architecture diagram for designing and using the motion planning and artifact builder microservices.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that several techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that can accept a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units. “Software” or “application” may refer to prescribed rules to operate a computer. Examples of software or applications may include code segments in one or more computer-readable languages; graphical and/or textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any practical order. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a microservice which solves task and motion plans using a graph-of-convex-sets approach. The goal is to achieve time-optimal robot trajectories that are guaranteed to satisfy constraints, such as collision avoidance, end-effector pose and recipe-specific dynamic limits. The planning service includes a plurality of microservices, including one or more of a motion planner, an artifact builder, a visualizer, a planner, a service API and a service client. The planning service can use a combination of discrete and smooth optimizations under a graph of convex sets approach. Details of each of these components are described in greater detail below.

The motion planner is a service that provides an application programming interface (API) to transmit a motion planning problem, specified by the following: (1) a robot model based on a specific convenient format to aggregate unified robot description format (URDF) files, which are ubiquitous in the planning community; (2) a set of user-defined constraints on the robot pose, such as heterogeneous constraints that are multimodal in time and space, collision avoidance requirements and dynamic limits; and (3) the start state and goal state of the robot. The framework is generic enough to express a broad range of constraints typically used in robot motion planning.

A context can be defined as the combination of robot model and global constraints. The motion planner can, based on the motion planning problem, get back a plan, which is a function that maps time to robot joint positions, such that it can be easily commanded to drive robots on the plan (the hardware-specific driver software is typically not included in the motion planning software).

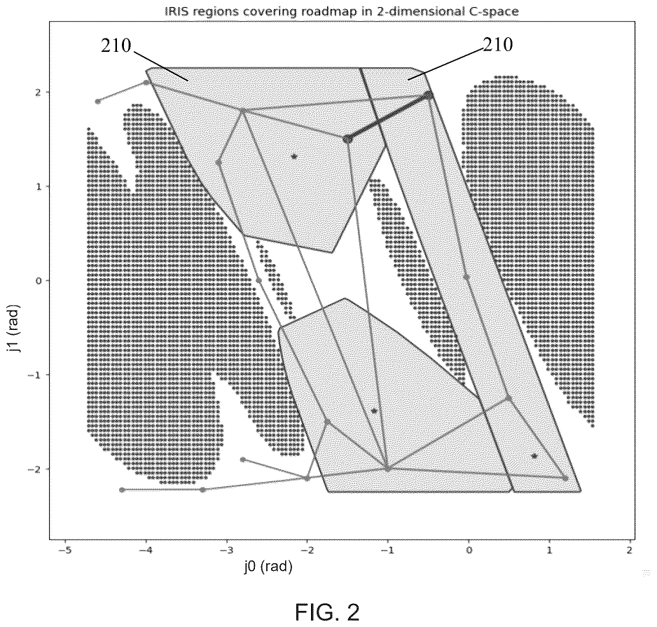

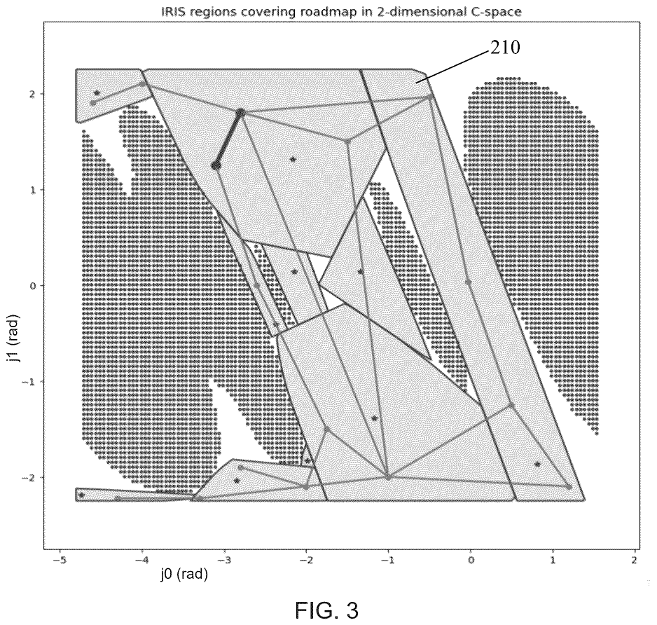

The artifact builder is a service that provides an API to generate planning artifacts for a given context. The planning artifacts include iterative region inflation via semidefinite programming (IRIS) regions, which are convex sets in the robot configuration space such that all the points in the set satisfy the constraints (e.g., collision avoidance and end-effector pose constraints). Such convex sets are illustrated as the convex regions 210 of FIG. 2, described below. The planning artifacts further include probabilistic roadmaps (PRMs) as a sampled graph representation of valid configurations and paths. Examples of the valid paths are shown by the smooth selection of control points 300 illustrated in FIG. 3. The artifact builder is typically run ahead of on-robot operation, and its generated artifacts deployed alongside the motion planner at runtime.

The visualizer is a service that provides an API to display a given context in a live visualizer session, such as in a Meshcat visualizer session, as well as tools to interact with the session, including one or more of the following: (1) visualization of planning artifacts (IRIS regions, PRMs); (2) visualization of geometric constraints (bounding box on an end effector position constraint, coloring of collision violations, and the like); (3) trajectory playback; (4) joint sliders; and (5) position streaming support for live robots.

The planning service can support a range of planners. Graph of convex sets (GCS) is a planner tailored in a way that makes it much faster and suitable for online use. This planner uses IRIS artifacts that are constructed beforehand.

The planning service can also use sampling-based methods that are used from the off-the-shelf library from open motion planning library (OMPL). These sampling-based methods are tailored to efficiently plan on aforementioned contexts. This planner works much faster if PRMs are constructed beforehand. It still can solve planning problems, albeit slower, without any artifacts.

The planning service can also use inverse kinematics (IK). IK is an optimization-based approach to find joint positions from specific robot poses. According to embodiments of the present invention, a method is developed to plan from plans involving a sequence of poses such that optimization problems run in parallel, yielding a final plan faster.

According to embodiments of the present invention, the planning service can include a service API to receive requests based on, for example, Google's Remote Procedure Calls (gRPC) framework. These requests include, but are not limited to, planning problem definitions, artifact generation, robot pose calculation, and checking the satisfaction of the constraints.

According to embodiments of the present invention, the planning service system can include a service client, which is software to interact with the planning-service. A typical user will only work with this software. Since gRPC protocols are agnostic to the programming-language, the service client can support programming in multiple languages, including, for example, C++ and python interfaces.

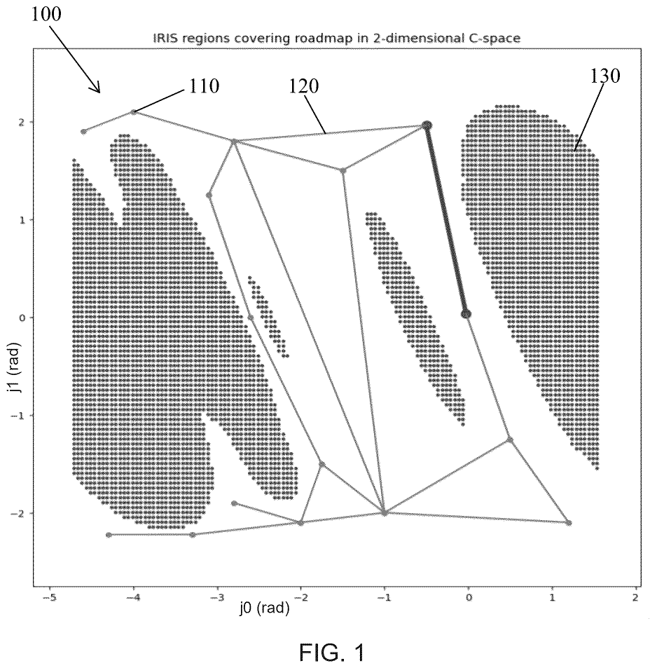

As seen in FIG. 1, embodiments of the present invention provide a planning service that can utilize a graph of convex sets (GCS) approach, which includes a combination of discrete and smooth optimization. Optimization on graphs is fast, but, as shown in FIG. 1, discrete by nature. In the graph 100 of FIG. 1, discrete locations 110 are connected by edges 120 to avoid obstacle regions 130.

The GCS is an approximate convex decomposition of the valid (e.g., collision-free) configuration subspace. FIG. 2 shows convex regions 210 and obstacle regions 130 in the graph 200. The construction of the convex regions 210 can use a pipeline to generate convex regions (also referred to as convex sets) from constraints on robot position, such as collision avoidance constraints and pose constraints on the end effector(s) are satisfied for all the points in each convex set. These sets can be connected as a graph, such as graph 200.

As shown in FIG. 3, the GCS planner in planning service can provide a smooth selection of control points within the convex regions 210. Convex parameterization properties ensure correctness of splines. Convex optimization, such as mixed integer convex optimization, can be used to obtain optimal, smooth trajectories. FIG. 3 shows IRIS regions covering a roadmap in two-dimensional configuration space (C-space). GCS cover for sample-based planning can include generating polytopes from edges. This enables the planning service, according to embodiments of the present invention, to make GCS “covers” for PRMs and paths. This can preserve theoretical guarantees from sample-based planning, such as graph connectivity, planning with tight constraints, visibility coverage and the like.

The paths can be randomly generated, and an experience-based set of paths can be determined. The planning service can pre-defined important problems to solve and solve them offline. These solutions can be inserted into a database. A node insertion (and edge creation) algorithm have connectivity guarantees, where the roadmap is always connected when it can. This approach is particularly suited for difficult configuration spaces and can leverage strengths and optimalities of single-purpose planning techniques like RRT*, RRTConnect, and others.

The GCS approach can be used for geometrically constrained motions. Free space for constrained motions can be small, disconnected and wild. Experience-based roadmap covers relevant connected components and ensures connectivity inside each connected component. Generation from the connected roadmap ensures the properties of the roadmap are preserved in the GCS approach, thus providing relevant coverage and a connected graph.

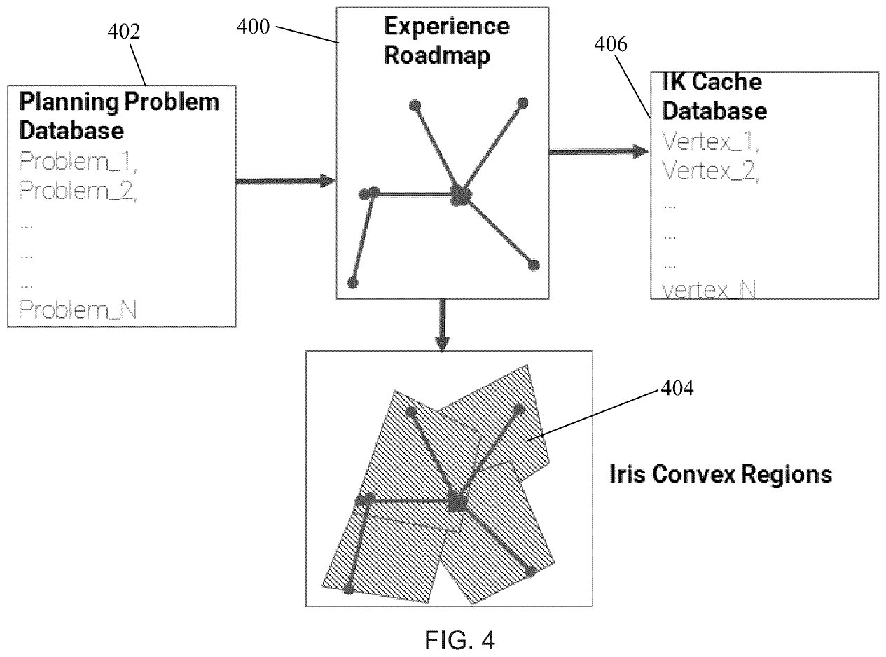

FIG. 4 illustrates how connected roadmaps 400 can be constructed from historical planning problems 402. The roadmap 400 can be used to build artifacts, such as IRIS regions 404 and IK case databases 406. The artifacts can get continuously updated with more planning problems requested by running robots.

IK seeds can be determined from the roadmap, such as roadmap 400. Embodiments of the present invention can collect the robot frame pair poses requested on the robot. This data can be used to compute frame pair poses of all the vertices in the roadmap. A custom distance metric can be used to pick the best seed to solve IK for a requested frame pair pose problem.

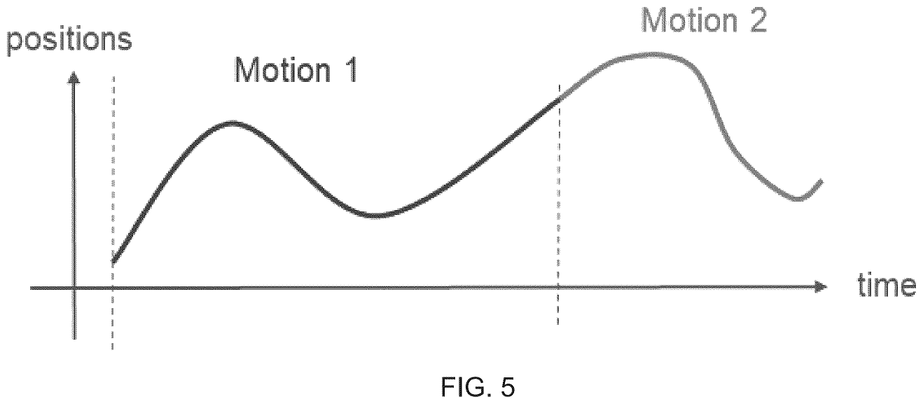

FIGS. 5 through 8 illustrate graphs of the motion splines for one or more robots over time. In FIG. 5, it can be seen that embodiments of the present invention can allow for motion splines to be updated on-the-fly in a smooth way such that robot hardware is able to execute the change of motion without the need to come to a full stop.

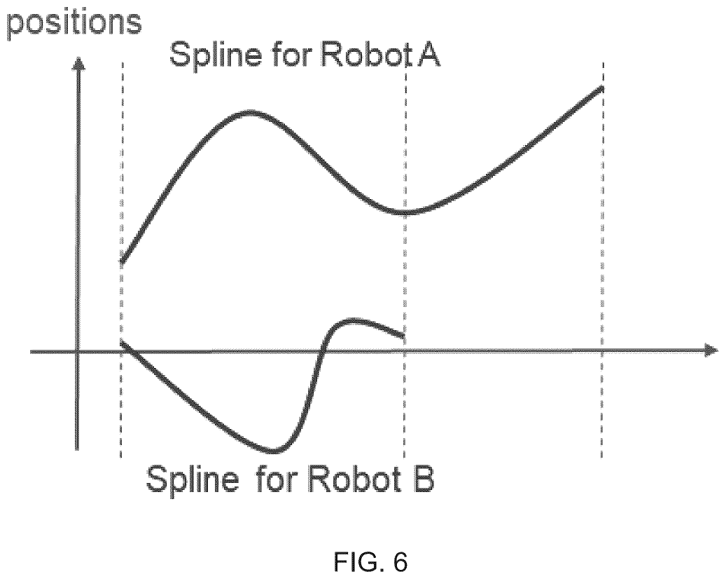

In FIG. 6, embodiments of the present invention can allow motion splines to be computer for multiple arms such that the end time for each arm is different, depending on the desired goals and arm dynamics, while constraints, such as collision-avoidance, are respected. This allows for the faster arm to be freed up for the next motion.

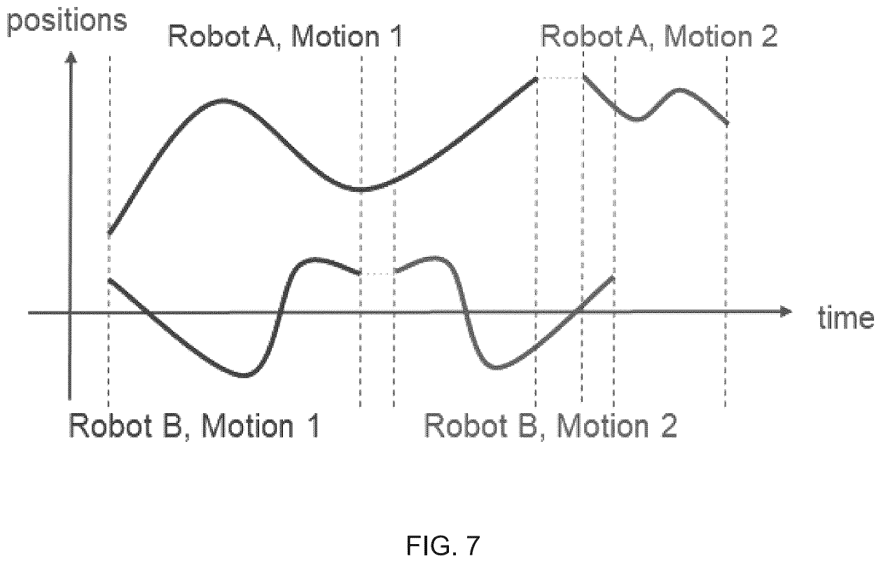

In FIG. 7, embodiments of the present invention can allow motion splines to be computed for one or more robots while plans for the other arm(s) are running. This can be done in a way that the aggregate motions are satisfying the user-specified constraints and are collision-free

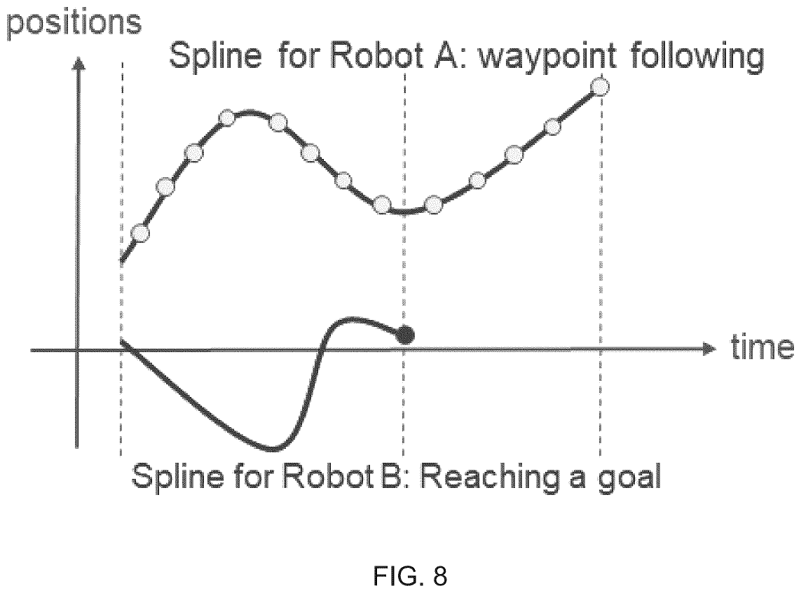

In FIG. 8, embodiments of the present invention can allow motion splines to be provided across multiple robots with different types of plans. For example, the plan for one robot may be the waypoint following (Robot A in FIG. 8), while the plan for another robot can be reaching a goal (Robot B in FIG. 8).

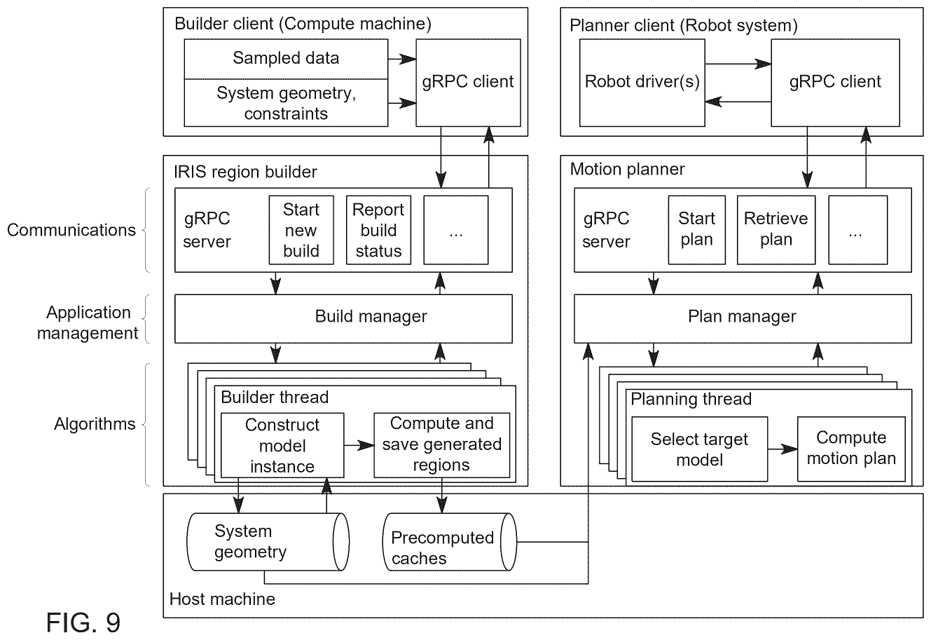

FIG. 9 illustrates a software architecture for the motion planning service according to embodiments of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A motion planning system for providing a motion plan for robot motion, comprising:
a motion planner receiving a motion planning problem and generating the motion plan;
an artifact builder generating one or more planning artifacts;
a visualizer displaying the given context in a visualizer session; and
a service client providing an interface for an end user.

2. The motion planning system of claim 1, wherein the motion planning problem includes a robot model, a set of user-defined constraints, start state data and goal state data for a robot.

3. The motion planning system of claim 2, wherein the motion plan is provided as a function that maps time to robot joint positions in order to drive the robot under the motion plan.

4. The motion planning system of claim 2, wherein the artifact builder generates the one or more planning artifacts based on the robot model and the set of user-defined constraints.

5. The motion planning system of claim 4, wherein the one or more planning artifacts include iterative region inflation via semidefinite programming regions and probabilistic roadmaps.

6. The motion planning system of claim 5, wherein the artifact builder is operable to run ahead of on-robot operation, and to deploy the one or more generated planning artifacts alongside the motion planner at runtime.

7. The motion planning system of claim 1, wherein the visualizer further provides one or more of visualization of the generated planning artifacts, visualization of geometric constraints, visualization of a trajectory playback, visualization of joint sliders and position streaming support for live robots.

8. The motion planning system of claim 1, further comprising a service application programming interface to receive service data.

9. The motion planning system of claim 8, wherein the service data include one or more of planning problem definitions, artifact generation, robot pose calculation and checking for a satisfaction of constraints.

10. A method for generating a motion plan for robot motion, comprising:
receiving a motion planning problem and generating the motion plan by a motion planner;
generating one or more planning artifacts for a given context with an artifact builder;
displaying one or more of a visualization of the generated planning artifacts, a visualization of geometric constraints, a visualization of a trajectory playback, a visualization of joint sliders and a position streaming support for live robots in a visualizer session; and
providing a service client as an interface for an end user.

11. The method of claim 10, wherein the motion planning problem includes a robot model, a set of user-defined constraints, start state data and goal state data for a robot.

12. The method of claim 11, further comprising providing the motion plan as a function that maps time to robot joint positions in order to drive the robot under the motion plan.

13. The method of claim 10, wherein the one or more planning artifacts include iterative region inflation via semidefinite programming regions and probabilistic roadmaps.

14. The method of claim 13, further comprising running the artifact builder ahead of on-robot operation, and deploying the one or more generated planning artifacts alongside the motion planner at runtime.

15. The method of claim 10, further comprising receiving service data with a service application programming interface, the service data including one or more of planning problem definitions, artifact generation, robot pose calculation and checking for a satisfaction of constraints.

16. The method of claim 10, wherein the motion plan provides a motion spline that includes one or more of (1) a smooth update between a first motion and a second motion without requiring a full stop of a robot; (2) permitting multiple arms to end at different times and permitting a faster arm of the multiple arms to be freed for a subsequent motion; (3) computing motion plans for one or more robots while motion plans for other arms are running; and (4) permitting heterogeneous plans.

17. A non-transitory computer readable storage medium tangibly embodying a computer readable program code having computer readable instructions that, when executed, causes a computer device to carry out a method of generating a motion plan for robot motion, the method comprising:
receiving a motion planning problem and generating the motion plan by a motion planner;
generating one or more planning artifacts for a given context with an artifact builder;
displaying one or more of a visualization of the generated planning artifacts, a visualization of geometric constraints, a visualization of a trajectory playback, a visualization of joint sliders and a position streaming support for live robots
in a visualizer session; and
providing a service client as an interface for an end user.

18. The non-transitory computer readable storage medium of claim 17, wherein the motion planning problem includes a robot model, a set of user-defined constraints, start state data and goal state data for a robot.

19. The non-transitory computer readable storage medium of claim 18, wherein the method further comprises providing the motion plan as a function that maps time to robot joint positions in order to drive the robot under the motion plan.

20. The non-transitory computer readable storage medium of claim 17, wherein the one or more planning artifacts include iterative region inflation via semidefinite programming regions and probabilistic roadmaps.
